(19) United States
(12) Patent Application Publication
(10) Pub. No.: US 2007/0067187 A1
(43) Pub. Date: Mar. 22, 2007

(54) ELECTRONIC LIFESTYLE INTEGRATION APPARATUS AND METHOD OF ESTABLISHMENT

(75) Inventor: Cheng-Chou Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 11/532,104

(22) Filed: Sep. 15, 2006

(30) Foreign Application Priority Data
Sep. 22, 2005 (TW) 94132767

(51) Int. Cl. G06Q 10/00; G06Q 50/00

(52) U.S. Cl. 705/2

(57) ABSTRACT

An electronic lifestyle integration apparatus is provided. The electronic lifestyle integration apparatus comprises an input unit, a memory unit, a radio frequency (RF) unit, a display unit, a central processing unit (CPU) and a timer. The input unit chooses a plurality lifestyle information items. Then, the life information items are recorded in the memory unit. The RF unit is able to catch and download the content of life information items. Eventually, the display unit displays the content of the lifestyle information items. The CPU controls the input unit, the memory unit, the radio frequency (RF) unit and the display unit. The timer repeatedly counts down a predetermined time period and triggers the CPU to refresh the related content of lifestyle information items when each time the counting down is ended.

### CROSS-REFERENCE TO RELATED APPLICATION

This application claims the priority benefit of Taiwan application serial no. 94132767, filed Sep. 22, 2005. All disclosure of the Taiwan application is incorporated herein by reference.

### BACKGROUND OF THE INVENTION

1. Field of Invention

The present invention relates to an electronic lifestyle integration apparatus. More particularly, the present invention relates to an electronic lifestyle integration apparatus and method of establishment which is able to automatically catch and display lifestyle contents.

2. Description of Related Art

Recently, along with the internet coming in vogue, there are many revolutionary changes in people's lifestyles, which has also brought many conveniences which were never had before. To incorporate the convenience of the internet going from a desktop to a smaller sized, lighter weight, and easily portable mobile apparatus, to allow the user to receive messages at anytime and anywhere; as a result, people in the industry has founded the WAP forum in June, 1997 for establishing together the unified specification for wireless access to the internet, which is the so-called WAP (Wireless Application Protocol).

WAP is an open and standardized protocol. It is mainly used to transfer and display information content for systems based upon the Global System for Mobile communications (GSM) and other wireless terminal devices, and also for providing many other premium services. As a result of the specification establishment of WAP, the mobile phone manufacturers, system service providers, and content providers around the world have a specified set of rules to follow. Therefore, established from the beginning, it has attracted many firms to join in. Due to the establishment of WAP, a global wireless standard for software development was therefore established to support all of the wireless network technologies. Therefore, the typical contents on the internet and the premium information services are able to be delivered to the cellular phones and other wireless devices.

A common user is often able to obtain an abundant number of services using WAP. For example, based upon the services offered by content service providers, the user is able to obtain services of several general types such as lifestyle information, leisure entertainment, electronic commerce, intelligence database searching, mailing & packaging delivery, and customer services via cellular phone using WAP. Under the category of electronic commerce, services for mobile banking, electronic trading, airline booking, hotel booking, and movie ticket booking are provided. In addition, via WAP together with satellite positioning, regardless of where the user is, he is able to fetch the most needed news anywhere and anytime by using the functions of the satellite positioning.

However, although using services provided by WAP, the user is able to use the mobile apparatus in his hand to perform the functions of the internet using wireless methods. However, when the WAP functions are performed on the mobile apparatuses, due to factors such as the limitations of the input/output capabilities of the mobile apparatus, size of the memory, and the performing capability of the CPU, the display browser is not as convenient as the WWW browser of the desktop; therefore, when the current user performs internet access functions using a mobile apparatus, he needs mostly only to fetch some simple informational content, such as for weather conditions, traffic information and so on.

However, the user has to go through complicated procedures each time he wants to obtain the aforementioned information. First, he needs to access the internet via the WAP, and then access the related web pages for obtaining the informational content that he wants. Furthermore, when the user wants to read different information, he has to repeat the same steps many times for collecting different information. Moreover, the conventional WAP service is unable to perform the function of data integration. In the aforementioned situation, the user will feel very inconvenient during use, as well as not in compliance with economic efficiency.

### SUMMARY OF THE INVENTION

Accordingly, the present invention is directed to provide an electronic lifestyle integration apparatus which can automatically integrate a plurality of lifestyle information items chosen by the user and periodically refresh the items and display them on the screen, so that the user can easily access the needed information contents.

The present invention is also directed to provide a method of establishment for an electronic lifestyle integration apparatus which can automatically load and periodically refresh a plurality of lifestyle information items that the user needs, so that the user is able to simultaneously read a plurality of information items. Moreover, in the method of establishment, a variety of 3D images may also be downloaded to respond to the state of each lifestyle information item, so that the user of the electronic lifestyle integration apparatus is able to clearly acquire the content of each lifestyle information item.

The present invention provides an electronic lifestyle integration apparatus, which comprises an input unit, a memory unit, a radio frequency (RF) unit, a display unit, a central processing unit (CPU) and a timer. Wherein, the input unit chooses a plurality of lifestyle information items, the memory unit records the lifestyle information items chosen by the input unit. The RF unit searches and downloads the related content of the lifestyle information items, and the display unit displays the lifestyle information items and the related content of the lifestyle information items chosen by the input unit. The CPU connects and controls the input unit, the memory unit, the radio frequency (RF) unit, and the display unit. The timer counts down repeatedly a predetermined time period and triggers the CPU to refresh the content of the lifestyle information items when each time the counting down is ended.

According to the preferred embodiment of the present invention, the memory described above is a non-volatile memory.

According to the preferred embodiment of the present invention, the radio frequency (RF) unit described above transmits the information via the method of wireless network transmission mode or blue tooth.

According to the preferred embodiment of the present invention, the plurality of lifestyle information items described above includes at least traffic information and weather conditions.

According to the preferred embodiment of the present invention, the display unit described above displays the lifestyle information in 3D way. Wherein, the RF unit researches and downloads a plurality of sets of 3D images, each set of the 3D images is displayed on the display unit to illustrate the status of each life information item.

According to the preferred embodiment of the present invention, the electronic lifestyle integration apparatus described above is a cellular phone.

According to the preferred embodiment of the present invention, the electronic lifestyle integration apparatus described above further includes an information parser which connects to the RF unit and chooses the lifestyle information items chosen by the input unit.

Moreover, the present invention provides a method of establishment for an electronic lifestyle integration apparatus, which comprises loading a plurality of lifestyle information items that the user wants to read; downloading the content of lifestyle information items described above and refreshing the related content of the lifestyle information items during a pre-established interval; and displaying the status of the lifestyle information items that the user wants to read.

According to the preferred embodiment of the present invention, the method of establishment described above records the lifestyle information items that the user chooses.

According to the preferred embodiment of the present invention, the method of establishment described above downloads the lifestyle information items via wireless network transmission mode or blue tooth.

According to the preferred embodiment of the present invention, the method of establishment described above illustrates the status of the lifestyle information items chosen by the user in 3D method.

According to the preferred embodiment of the present invention, the steps of downloading a plurality of life information items described above further comprise, first, capturing a plurality of network information; interpreting the network information; and then, choosing 3D images.

According to the preferred embodiment of the present invention, the method of establishment described above can automatically refresh the content of each lifestyle information item.

As the present invention can automatically search, download and periodically refresh a plurality of life information items that the user needs, the multiple enquiries by accessing internet via WAP are not necessary any more, so that the user can easily access and read the latest and necessary information content. In the meantime, the present invention can display a plurality of lifestyle information items on the screen simultaneously and illustrate the status of each lifestyle information item in a variety of 3D images, so that the user is able to know the status of each lifestyle information item more clearly.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of an electronic lifestyle integration apparatus according to a preferred embodiment of the present invention.

FIG. 2 is a flow chat of method of establishment for an electronic lifestyle integration apparatus according to a preferred embodiment of the present invention.

### DESCRIPTION OF EMBODIMENTS

The electronic lifestyle integration apparatus according to a preferred embodiment of the present invention, the major characteristic is that it can automatically search and download each content of lifestyle information items that the user needs, and display each lifestyle information item that the user wants to know on the screen simultaneously in a variety of 3D image, so that the user is able to quickly and clearly know the status of each content of the lifestyle information item.

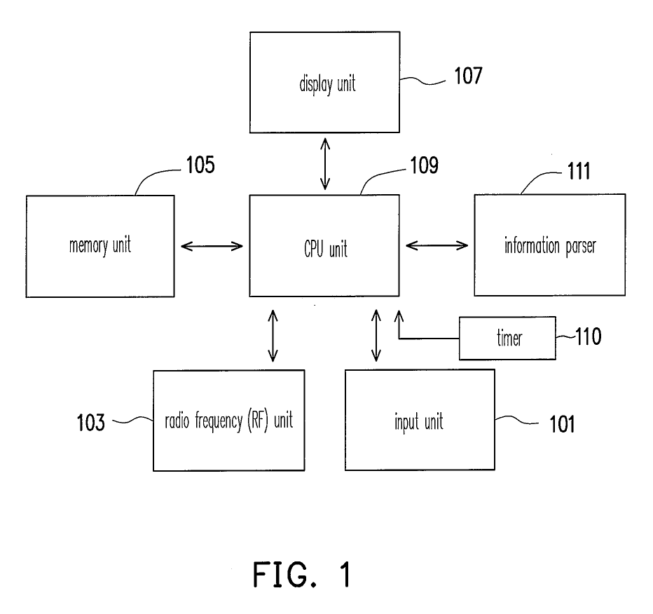

FIG. 1 is a schematic block diagram of an electronic lifestyle integration apparatus according to a preferred embodiment of the present invention. Referring to FIG. 1, the schematic block diagram of the electronic lifestyle integration apparatus comprises an input unit 101, a memory unit 105, a radio frequency (RF) unit 103, a display unit 107, a central processing unit (CPU) 109 and a timer 110.

In the embodiment, in order to let the user freely choose the wanted content of lifestyle information items, the electronic lifestyle integration apparatus can pre-build in various types of lifestyle information options and display them on the screen of the display unit 107. Thus, the user can choose the lifestyle information options provided by the display unit 107 via the input unit 101 described above. Then, the electronic lifestyle integration apparatus automatically catches, downloads and displays the results on the screen of the display unit 107.

After the user chooses the wanted lifestyle information options from the option list provided by the display unit 107, the memory unit 105 records the lifestyle information options chosen by the user. When the user needs to reset the chosen lifestyle information options, the previous option establishment can be read from the memory unit 105 to facilitate the user's operation. Wherein, the memory unit 105 can be a non-volatile memory, therefore, when the electronic lifestyle integration apparatus is re-started after power-off, the previous option establishment is still recorded in the memory unit. If the content of lifestyle information the user wants to choose is the same as the previous establishment, the same option establishment can be done by calling the previous establishment content from the memory unit 105.

After the user chooses specified lifestyle information options via the input unit 101, the RF unit 103 starts to catch and download the related content of the lifestyle information. Wherein, in order to enhance the efficiency of using the electronic lifestyle integration apparatus, the RF unit can be either wireless network transmission mode or blue tooth, but it is not limited hereby. Moreover, the CPU 109 couples to the input unit 101, the radio frequency (RF) unit 103, the memory unit 105 and the display unit 107 and operates and controls the actions of those units. In addition, the content of the lifestyle information that the electronic lifestyle integration apparatus can download includes the weather conditions, temperature changes or traffic information, and incorporation with the global satellite positioning, finally the lifestyle information that the user wants is displayed on the display unit 107 directly in an intuitive way, so that the user can obtain a plurality of lifestyle information items simultaneously in a rather intuitive way.

Moreover, the timer 110 counts down repeatedly a predetermined time period and sends out a trigger signal when each time the counting down is ended so as to trigger the CPU unit 109 to automatically capture related information from the internet according to the previous establishment by the user or the built-in establishment of the electronic lifestyle integration apparatus, and then refresh the information on the display unit 107.

In addition, during the RF unit 103 of the electronic lifestyle integration apparatus is catching or downloading the content of the lifestyle information, it may not be able to judge effectively if the downloaded information is the user wants, therefore an information parser 111 is further included in the electronic lifestyle integration apparatus. After the RF unit 103 downloads the related lifestyle information, the information parser 111 will judge and choose the lifestyle information chosen by the user and display the content on the display unit 107.

Wherein, the electronic lifestyle integration apparatus according to the embodiment of the present invention described above can be combined with Smart Phone, Personal Digital Assistant (PDA) or the widely used mobile phones, but it's not limited herein.

The content of the lifestyle information displayed on the display unit 107 of the electronic lifestyle integration apparatus can be the commonly used 2D way, or it can be displayed in 3D method. When the 3D method is used to display the information, due to the advantage of the depth of field, massive information can be displayed on the screen of the display unit 107 without causing any confusion to the user. In addition, the user may choose the wanted content of the lifestyle information by 3D pan/tilt/zoom (PTZ).

As described above, when the electronic lifestyle integration apparatus displays the content of the lifestyle information in 3D method, a variety of 3D images is needed to represent all different statuses, thus the electronic lifestyle integration apparatus may use the RF unit 103 to download all kinds of 3D images, and then the CPU 109 chooses the proper 3D image to display on the display unit 107 according to the status of each content of the lifestyle information, so that the user may obtain the status of all the content of the lifestyle information easily.

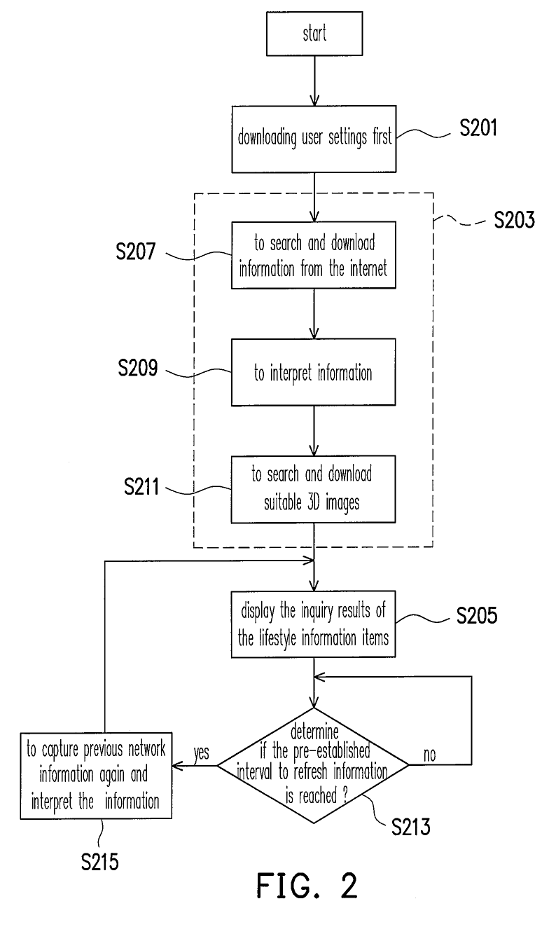

Referring to FIG. 2, FIG. 2 is an establishment flow chat of an electronic lifestyle integration apparatus according to a preferred embodiment of the present invention. The explanation of the flow chat of the electronic lifestyle integration apparatus will be given together with the units introduced in FIG. 1 as below.

As shown in FIG. 2, in step S201, first, the user settings are downloaded. This step represents the content of the lifestyle information that the user wants to choose. If explaining together with the schematic block diagram of FIG. 1, it means that the user can choose a plurality of wanted lifestyle information from the display unit 107 via the input unit 101.

Then, in step S203, a plurality of lifestyle information items are started to be downloaded. Corresponding to the schematic block diagram of FIG. 1, the electronic lifestyle integration apparatus starts to search and download a plurality of wanted lifestyle information items chosen in step S201 by the built-in RF unit 103. Wherein, the method of downloading the lifestyle information items described above can be performed by a wireless transmission mode; of course, those skilled in the art can easily know that, the wireless transmission mode can be the wireless network transmission mode or blue-tooth. However, it should not be limited herein.

And then, in step S205, the electronic lifestyle integration apparatus can display the inquiry results of the lifestyle information items for the user to read and use. If explaining by the embodiment shown in FIG. 1, it means that each of the lifestyle information items that the user wants to query is displayed on the display unit 107.

Wherein, step S203 described above further comprises three steps S207˜S211. First, in step S207, the electronic lifestyle integration apparatus uses the RF unit 103 to search and download information from the internet. Then, in step S209, the electronic lifestyle integration apparatus interprets the downloaded content of the lifestyle information items and chooses the correct content of the information. Corresponding to the embodiment shown in FIG. 1, it means that the information parser built in the electronic lifestyle integration apparatus checks the received information and filters the unnecessary content of the lifestyle information items.

As described in the embodiment of FIG. 1, the display unit 105 of the electronic lifestyle integration apparatus may display the status of the lifestyle information items by 3D method. Thus, when the electronic lifestyle integration apparatus wants to display the information in 3D images, in step S211, suitable 3D images have to be searched and downloaded according to the statuses of the lifestyle information items; and in step S205, the status of each lifestyle information item chosen by the user will be illustrated in 3D image.

In addition, the electronic lifestyle integration apparatus also records every lifestyle information option chosen by the user. When the user wants to choose the same lifestyle information option he chose last time, the establishment can be done by just calling the previous recorded content.

In addition, the electronic lifestyle integration apparatus has an establishment to automatically refresh the content of the lifestyle information periodically. After displaying of the lifestyle information items in step S205, the electronic lifestyle integration apparatus will judge if it reaches the pre-established interval to refresh information (step S213). Once reaching the pre-established interval, the electronic lifestyle integration apparatus will capture previous network information again and interpret the information (step S215), and refresh and display the latest result on the display unit. Thereby, the information that constantly changes such as temperature or the user's positioning information can be obtained so that the user will be updated of the newest lifestyle information through the electronic lifestyle integration apparatus which refreshes information continuously. Herein, the pre-established interval can be set by the user or be decided by the internal pre-established value of the electronic lifestyle integration apparatus.

In conclusion, the electronic lifestyle integration apparatus and establishment method according to the present invention can automatically catch and periodically refresh and download a plurality of lifestyle information items that the user needs; and the user need not to access the internet to inquire via WAP for many times; therefore, the user can obtain the newest information content at any time. Furthermore, the present invention can display a plurality of lifestyle information items on the screen simultaneously and illustrate the statues of the lifestyle information items by 3D images, so that the user can understand the status of each information item more clearly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic lifestyle integration apparatus, comprising:
an input unit, used for selecting a plurality of lifestyle information items;
a memory unit, used for recording the lifestyle information items chosen by the input unit;
a radio frequency unit, used for catching and downloading of the related contents of the lifestyle information items;
a display unit, used for displaying the lifestyle information items chosen by the input unit and the related content of the lifestyle information items;
a central processing unit, used to connect and control the input unit, the memory unit, the radio frequency unit, and the display unit; and
a timer, used for counting down repeatedly a predetermined time period, and triggering the central processing unit to refresh the related content of the lifestyle information items when each time the counting down is ended.

2. The electronic lifestyle integration apparatus as claimed in claim 1, wherein the memory is a non-volatile memory.

3. The electronic lifestyle integration apparatus as claimed in claim 1, wherein the transmission of the radio frequency unit is via wireless network transmission mode.

4. The electronic lifestyle integration apparatus as claimed in claim 1, wherein the transmission of the radio frequency unit is via blue tooth.

5. The electronic lifestyle integration apparatus as claimed in claim 1, wherein the lifestyle information items include at least traffic information, and weather conditions.

6. The electronic lifestyle integration apparatus as claimed in claim 1, wherein the display unit displays the lifestyle information in 3D type.

7. The electronic lifestyle integration apparatus as claimed in claim 6, wherein the radio frequency unit is able to catch and download a plurality of sets of 3D images, wherein the 3D images are displayed on the display unit for illustrating the state of the lifestyle information.

8. The electronic lifestyle integration apparatus as claimed in claim 6, wherein the electronic lifestyle integration apparatus is a cellular phone.

9. The electronic lifestyle integration apparatus as claimed in claim 6, wherein the electronic lifestyle integration apparatus further includes an information parser which connects to the radio frequency unit and chooses the lifestyle information items chosen by the input unit.

10. A method of establishment for an electronic lifestyle integration apparatus, having a display unit, comprising:
loading the related content of the lifestyle information items and refreshing the related content of the lifestyle information items during a pre-established interval; and
displaying the related contents of the different lifestyle information items on a plurality of specified positions of the display unit respectively corresponding to the downloading results.

11. The method of establishment for the electronic lifestyle integration apparatus as claimed in claim 10, wherein the method of establishment is able to record the lifestyle information items that the user chooses.

12. The method of establishment for the electronic lifestyle integration apparatus as claimed in claim 10, wherein the method of establishment downloads the lifestyle information via wireless network transmission mode.

13. The method of establishment for the electronic lifestyle integration apparatus as claimed in claim 10, wherein the method of establishment downloads the life information via blue tooth.

14. The method of establishment for the electronic lifestyle integration apparatus as claimed in claim 10, wherein the method of establishment displays the status of the lifestyle information items chosen by the user in 3D method.

15. The method of establishment for the electronic lifestyle integration apparatus as claimed in claim 14, wherein the steps of downloading the lifestyle information content further comprising:
capturing a plurality of network information;
interpreting the network information; and
choosing 3D images.

16. The method of establishment for electronic lifestyle integration apparatus as claimed in claim 10, wherein the pre-established interval is set by the user.

17. The method of establishment for electronic lifestyle integration apparatus as claimed in claim 10, wherein the pre-established interval is determined by a pre-established internal value in the electronic lifestyle integration apparatus.
